(19) United States
(12) Patent Application Publication
(10) Pub. No.: US 2011/0298910 A1
(43) Pub. Date: Dec. 8, 2011

(54) MIRROR DEVICE

(75) Inventors: Gerard De Haan, Eindhoven (NL); Frederik Jan De Bruijn, Eindhoven (NL); Wilhelmus PETRUS Van Der Meer, Eindhoven (NL)

(73) Assignee: KONINKLIJKE PHILIPS ELECTRONICS N.V., EINDHOVEN (NL)

(21) Appl. No.: 13/201,994

(22) PCT Filed: Feb. 15, 2010
(86) PCT No.: PCT/IB10/50670

§ 371 Date: Aug. 17, 2011

(30) Foreign Application Priority Data
Feb. 23, 2009 (EP) 09153393.5

(51) Int. Cl. H04N 7/18

(52) U.S. Cl. 348/77; 348/E07.085

(57) ABSTRACT

Mirror device (1) comprises a display device (3) and a camera (2) to record an image. The device comprises means for determining (4, 41) the position of a body part. Said means put out a signal (S) indicative of the position of the body part with respect to the a display screen of a display device (3) for a viewer in front of the mirror device. In dependence of this signal (S) the view point from which the to be displayed image is recorded is changed.

### FIELD OF THE INVENTION

The invention relates to a mirror device and to a device having a frame for a display device.

### BACKGROUND OF THE INVENTION

Mirror devices have been know for a very long time, in fact since Roman times and before.

Mirror devices are regularly used for all kinds of purposes and in all kinds of places, such as for applying make-up, at barber shops, and in dressing rooms.

A frequently occurring problem with mirrors is that the area one wants to see is just out of sight. If one wants to apply make-up on some parts of the face, or wants to shave some parts of the face, the particular part is often just out of sight. One can turn the head to get a better view, but often, to the aggravation of the viewer, as the head is turned to get a good look at the part, the particular part moves out of sight. A similar problem occurs in dressing rooms and changing cubicles. To see how a dress is hanging, one has to turn the body and the head. However, one never really gets a good look, and for many people the angle of turning is relatively small. Most people are not very agile. A similar problem occurs when one wants to get a closer look at a certain part of the face. One can get closer to the mirror, but often this will mean that the particular part gets out of sight and/or one cannot get the part in focus.

It is an object of the present invention to reduce one or more of the above problems.

### SUMMARY OF THE INVENTION

To this end the mirror device in accordance with a first aspect of the invention comprises:

a display device with a display screen

at least one image recording device to record an image

a means to determine a position of a body part with respect to the display screen of the display device, said means outputting a indication signal to indicate the position of the body part of a viewer in front of the display screen

a means to change the view point from which the image is recorded in dependence on said indication signal

a means to display the recorded image on the display device.

For instance, when a person sits in front of the mirror device and turns his or her head, the orientation of the face in respect of the mirror device is determined. In a device according to the invention the turning of the head causes the view point from which the image is recorded to be adjusted. This allows a greater freedom in the area of view, and allows the mirror device to display those areas that are normally just out of sight. It also allows, in embodiments, to bring the point of view closer to the object, i.e. to magnify the displayed image.

In embodiments the body part is the head or face of a person, in other embodiments the body part is the torso.

The position may comprise one or more of the positional parameters, for instance the distance to the display screen, angle of turn of the head of torso in respect of the display screen, or derivates in time of such position parameters, such as movements to and/or from the display screen, i.e. changes in distances, or nodding of the head, i.e. a chance in turning angle, or in coordinates: x, y and or z coordinates, and/or angles of turn and/or dx/dt, dz/dt etc. The indication signal can, dependent on the embodiment of the invention, indicate the orientation of the head or body.

In embodiments the indication signal indicates changes in positions, such as movement of the head or body turning the face or body or moving the face or body to and/or from the mirror.

An example of a change in orientation is a swift nod of the head to the right. The movement determining means interprets such a nod as indicating that a left side view of the head is to shown.

Using movements can have the advantage that a person can view the side of the head, while yet keeping the head in a “normal position”. A nod to the right, followed by a slow returning of the head to a normal position will enable the viewer to shift the view to a left side of the head; a nod to the left, followed by a slow return to a normal position will enable to see the right side of the head.

In embodiments, the means to change the view point are arranged to increase the angle of turn of the display imaged in respect of a reflected image. The angle of turn is the angle at which a head of body is displayed in the mirror in comparison to displaying a face looking straight at the mirror. This angle is, for mirrors, determined by the simple rule that the angle of incidence equals the angle of reflection, i.e. the turn angle is the same as the angle at which the head is turned. If one turns the head 10 degrees to the right standing in front of a normal mirror the image of the face one sees in the normal mirror is also turned 10 degrees. In a device according to this preferred embodiment the image of the head would be turned more than 10 degrees, for instance 20 degrees.

When one looks in a mirror the image seems to be positioned behind the mirror, and the position of this image is determined by the reflection in the mirror. When one looks in a flat mirror the angle of view is geometrically restricted. By choosing the position of the view point such that the angle of view is increased compared to the geometrical angle of view when looking in a mirror, the viewer is able to see beyond the normal range of view, and those areas that are just out of view, have been moved into view. Increasing the angle of turn means that the head or body is rotated further than would be in a mirror image, and one would see those areas of the face that are normally just out of sight. Consequently one can apply make-up or shave areas carefully and keeping an eye on what one does, where in the past using a normal mirror, one would have to apply make-up or shave without actually seeing what one does.

The increase in the angle of view can be linear, i.e. a turn of x degrees of the head will turn the head in the display by x*y degrees where y is constant. In these embodiments the turning of the head is displayed in an exaggerated manner, but in a consistently exaggerated manner.

The increase can also be non-linear, wherein the increase in angle increases as the head is turned more.

In embodiments the means to change the point of view are arranged to change the magnification (M) of the displayed image, with respect to a reflected image.

This allows a viewer to change the magnification by for instance getting closer to the display screen. This is impossible with a normal flat mirror.

In embodiments the mirror device comprises a movable camera and means to move the movable camera, wherein the position of the movable camera is determined by the position of e.g. the head or body.

In embodiments the mirror devices comprises more than one camera, wherein the position or orientation of the image recording is determined by determining which camera or cameras are used to record the image.

In a simple embodiment only a single camera is used, so that the position is determined by the position of the single camera. The device is provided with means to move the camera. This is a mechanical solution for changing the point of view, i.e. the position of the camera.

In more sophisticated embodiments more freedom in the position of the camera can be obtained by combining electronically the images of more than one camera into a combined image. Such more sophisticated embodiments allow changing the position of the camera in a gradual manner and electronically by mixing signals of various cameras. A virtual camera position can be made and one is no longer bounded by the actual positions of the camera(s). All of the cameras can be fixed, or a mix of fixed and movable cameras can be used.

In embodiments the point of view is changeable in one direction, in more sophisticated embodiments in more than one direction. If one wants to look at the side of the head an enlargement of viewing possibilities in a left-right direction is useful; however, if one wants to look into one's own mouth an up-down increase in viewing angles is useful. In embodiments the position of recording can also be changed in a direction perpendicular to the display surface. In such embodiments an enlarged image can be provided.

In preferred embodiments the mirror device is provided with a reflective, semi-transparent layer in front of the display screen. Preferably the means for displaying the recorded image are arranged such that for a first range of positions, no image is displayed, whereby the reflective layer acts as a mirror, and for a second range of positions, the recorded image is displayed.

For a first range of positions, for instance orientations, for instance when the viewer is looking almost straight to the mirror device, as per example the head being turned not more than a few degrees to either side, no image is displayed. For those orientations of the head the mirror device acts as a normal flat mirror. Since no image is displayed, the viewer will not see the recorded image, but simply his or her own reflection in the reflective semi-transparent layer in front of the display screen. For a second range of positions, for instance when the viewer head is turned sideways more than a few degrees, indicating the viewer wishes to view the side of his or her head, the recorded image is displayed and the view point, i.e. the camera position, real or virtual, is such that the side of the head is recorded. The displayed image is visible through the semi-transparent layer. The position of the camera is governed by a signal indicating the determined orientation of the head, so by turning the head the viewer can choose which part of the head he would like to see. Using the display device only when certain orientations are determined also safes energy and increases the lifetime of the device. Most of the time a viewer will look almost straight at the display screen

In embodiments the reflective semi-transparent layer is a layer switchable between a first state with a relatively high reflectivity and relatively low transparency, and a second state with a relatively low reflectivity and high transparency.

When no image is displayed, the reflective semi-transparent layer can be switched to the first state and the device acts as a simple reflective mirror; when an image is displayed, the reflective semi-transparent layer is switched to the second state. An increase in contrast is thereby achieved.

In simple embodiment, wherein the layer is switchable between a reflective and transmitting state, one could have the display displaying the recorded image all of the time, and switch the layer between a reflective and transmitting state.

In embodiments the mirror device comprises a layer in front of the display screen that is switchable between a reflective and transparent state.

An intermediate layer switchable between a highly reflective non-transparent state and a highly transmitting state has a similar effect.

In another aspect of the invention a device is provided that comprises a frame with a recording device to record an image for a display device, a means to determine a position of a body part with respect to the frame, said means outputting a indication signal to indicate the position of the body part of a viewer with respect to the frame, a means to change the view point from which the image is recorded in dependence on said indication signal, a means to generate an image signal of the recorded image for display on a display screen of a display device.

The device with the frame allows upgrading a normal TV and/or a computer monitor of a PC to a device with the added function of a mirror device. This aspect of the invention has the advantage that the customer does not have to buy a specialized display, but can use his own device. This aspect can also be used on mobile displays, such as laptops.

### BRIEF DESCRIPTION OF THE DRAWINGS

These and further aspects of the invention will be explained in greater detail by way of example and with reference to the accompanying drawings, in which

FIG. 1 illustrates a conventional mirror and the problem with a conventional mirror

FIG. 2 illustrates a first embodiment of a mirror device according to the invention

FIG. 3 illustrates an effect of the invention.

FIG. 4 illustrates a second embodiment of a mirror device according to the invention

FIG. 5 illustrates a third embodiment of a mirror device according to the invention.

FIG. 6 illustrates embodiments of a mirror device according to the invention.

FIG. 7 illustrates a further embodiment of the invention.

FIG. 8 illustrates an exemplary relation between distance to the display screen and magnification of the image.

FIG. 9 illustrates a variation in body part position by rotation of the head.

FIG. 10 illustrates a variation in body part position by rotation of the torso,

FIG. 11 illustrates a fourth embodiment of a mirror device according to the invention.

FIG. 12 illustrates a further embodiment of the invention.

FIG. 13 illustrates a further embodiment of the invention.

FIG. 14 illustrates a further embodiment of the invention in which a frame is used for a display device.

The FIGS. are not drawn to scale. Generally, identical components are denoted by the same reference numerals in the FIGS.

### DETAILED DESCRIPTION OF PREFERRED EMBODIMENTS

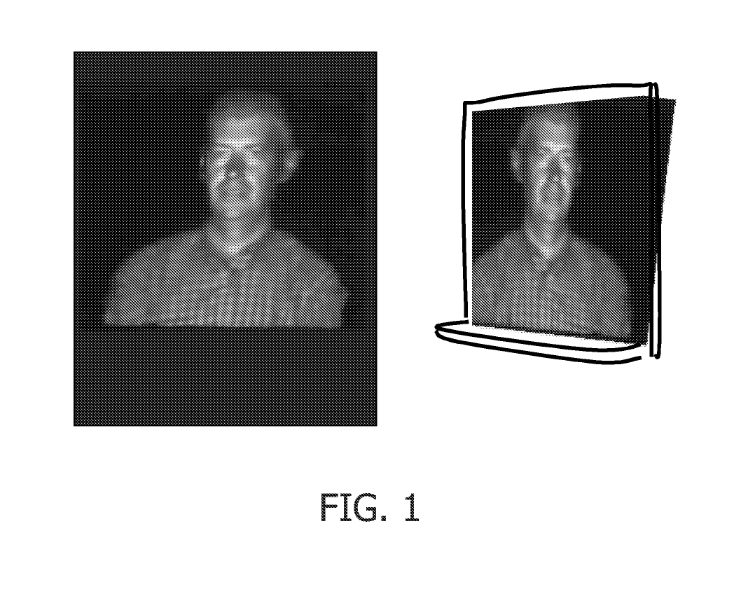

FIG. 1 illustrates a normal mirror. A normal mirror reflects the image of a person in front of the mirror. As a person turns his or her head or body, the image of the head or body in the mirror also turns, and over the same number of degrees as the head or body is turned. However, the maximum turn angle is determined by simple geometries. It is impossible, viewing into a mirror, to see the side of the head. If one wants to apply make-up on some parts of the face, or wants to shave some parts of the face, the particular part is often just out of sight. One can turn the head to get a better view, but often, to the aggravation of the viewer, as the head is turned to get a good look at the part, the particular part moves out of sight. A similar problem occurs in dressing rooms and changing cubicles. To see how a dress is hanging, one has to turn the body and the head. However, one never really gets a good look, and for many people the angle of turning is relatively small. Most people are not very agile. A similar problem occurs when one wants to get a closer look at a certain area of the face. One can get closer to the mirror, but often this will mean that the particular area gets out of sight and/or one cannot get the area in focus.

A viewer looking into a conventional mirror can see a frontal view at real size and only a little of the side views. It is known to use convex mirror to get a close-up view of for instance a part of the face, but even so, a viewer looking into a convex mirror can see an enlarged image, but still limited to mainly the frontal part.

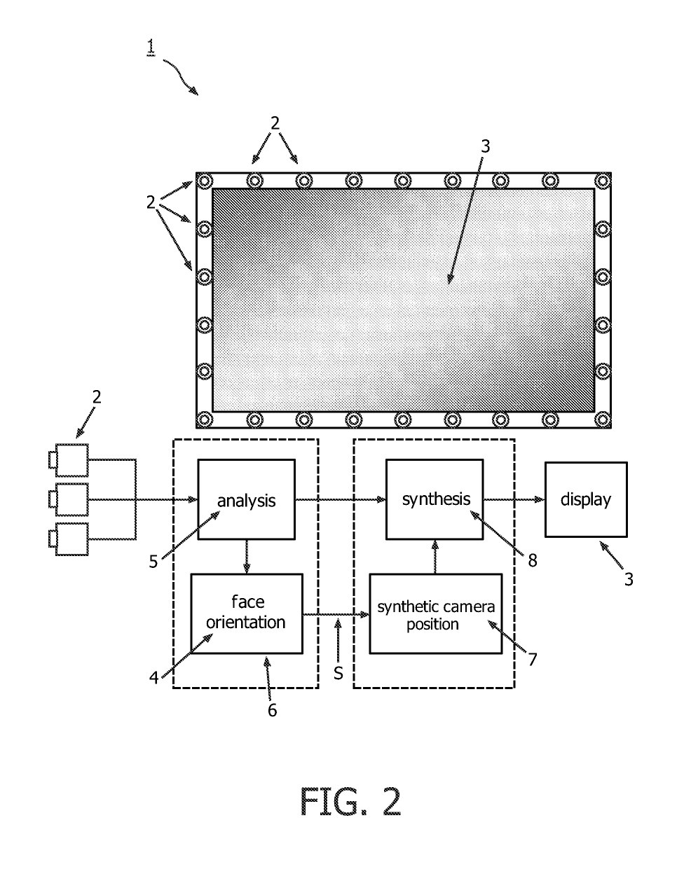

FIG. 2 illustrates a first embodiment of the invention.

The mirror device 1 comprises a number of cameras 2 and a display 3.

The recorded images by cameras 2 are fed to a position determination means 4. In the position determination means the images are analyzed in analyzing means 5 and in this example face orientation is determined in means 6. When a single image is analyzed, a coarse measure for the orientation of a head is for instance the ratio between the size of the head and the distance between the eyes, or the ratio between the distance between the eyes and the distance between the eyes and the mouth. Also clues such as the relative size (in horizontal direction) of the ears can be taken as a measure for the angle. When two images are taken 3-D analysis can be used to determine the angle of rotation of the head in respect of the mirror device and to determine the distance to the display screen. The face orientation is fed into a means for determining the position at which the image that is to be displayed is recorded. Using several cameras one can, by synthesis of the various images, construct a virtual camera position and/or magnification. The output of the face orientation determining means 6 is fed in to a synthetic position and magnification means 7, which determines the parameters for synthesizing the image to be displayed, which synthesizing is performed in synthesis means 8. The synthesized image is displayed on a display screen of the display device 3. The data from a number of cameras is, in this example, combined by the processing means to arrive at a single image signal from a virtual view point. The position of the virtual viewpoint is dependent on the determined face orientation, i.e. signal S. One could use the date of all, or a large number of the cameras for synthesizing the image.

In simple embodiments, instead of a synthesized image, the image of a particular camera is used for a particular range of orientation of the head. Such a solution, although within the scope of the invention, however could lead to an image that jumps from one camera position to another. An embodiment intermediate to the two above described embodiments is that, dependent on the signal S, the number of camera used for synthesizing the image is limited to a small number, for instance two or three around the optimal virtual position, instead of using all of the data from all the cameras.

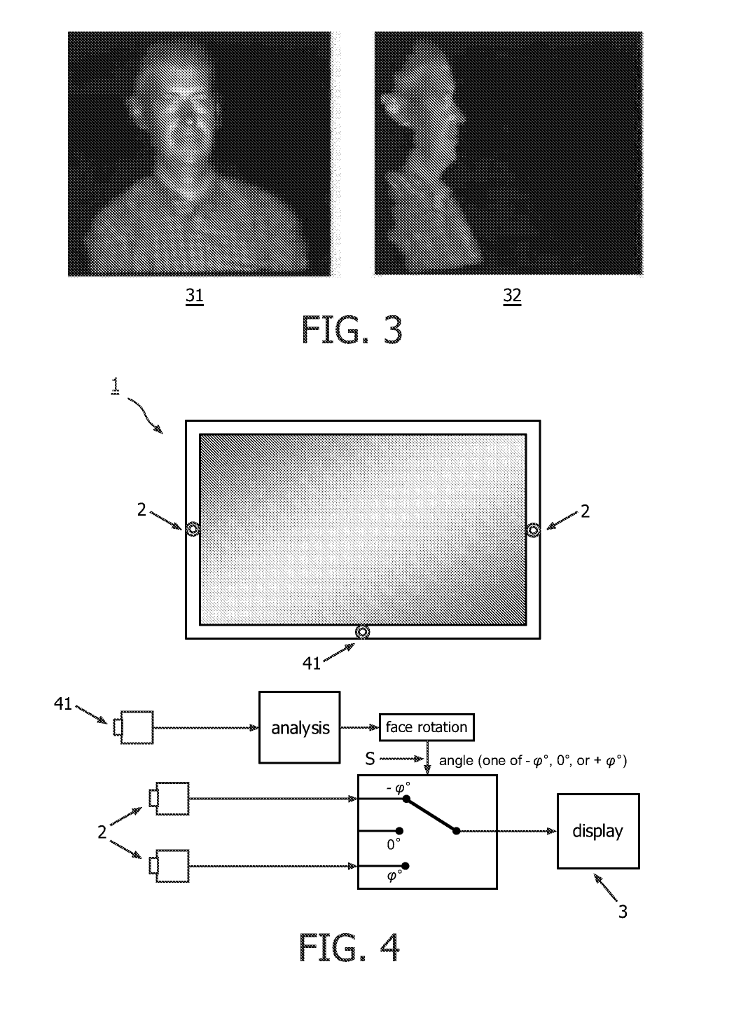

FIG. 3 illustrates the effect of the invention.

The orientation determining means establish for instance that the angle of turn of the head is 12 degrees. A normal mirror would then show the head being turned 12 degrees. This is shown for example in part 31. In the mirror device of the invention, the turning of the head can be exaggerated so that, instead of the head being displayed at a turning angle of 12 degrees, the turning angle (and thereby the camera position, i.e. the point of view from the image is recorded) is increased for instance 7-fold, so that a 12 degree turn of the head causes the head, as displayed on the display screen, to be turned 84 degrees.

FIG. 3 is a somewhat exaggerated example. In most applications the ratio between the actual turning angle of the head and the turning angle of the displayed head will be closer to 1 for instance a factor of 1.2 to 3, preferably between 1.3 and 2.

The amplification of the rotation should be great enough to have an appreciable effect, yet not so great that the enlargement of view and amplified rotation would not be perceived by the user intuitively as using a normal mirror.

In FIG. 2 the cameras are shown mounted in a frame of the display device, around the display. This is an embodiment. The cameras can be mounted at some distance from the framework, to increase the possible view points. The cameras, or at least some or one of them, can also be positioned some distance in front of the display. In embodiments the camera can be positioned in side parts attached to the mirror device. The mirror device can have for instance two closing doors, which open when the mirror device is used, wherein cameras are mounted around the perimeter of the display device, as shown in FIG. 2, as well as on the doors, so that the range of possible view points is increased.

FIG. 4 shows an embodiment of the invention.

In this embodiment the means for determining the orientation comprise an orientation sensing camera 41. The image taken by the orientation sensing camera determines the angle of rotation of the head in respect of the mirror. This is done in analysis means 42. When the determined angle is below a threshold value, the display device is not turned on, and the device acts as a normal mirror. When it is determined that the head is turned to the left or right over an angle more than the threshold, the right side camera is switched on and the image of the right side camera is displayed on the display device and vice versa.

Instead of an orientation sensing camera other means for sensing orientation, such as for instance ultrasound means may be used.

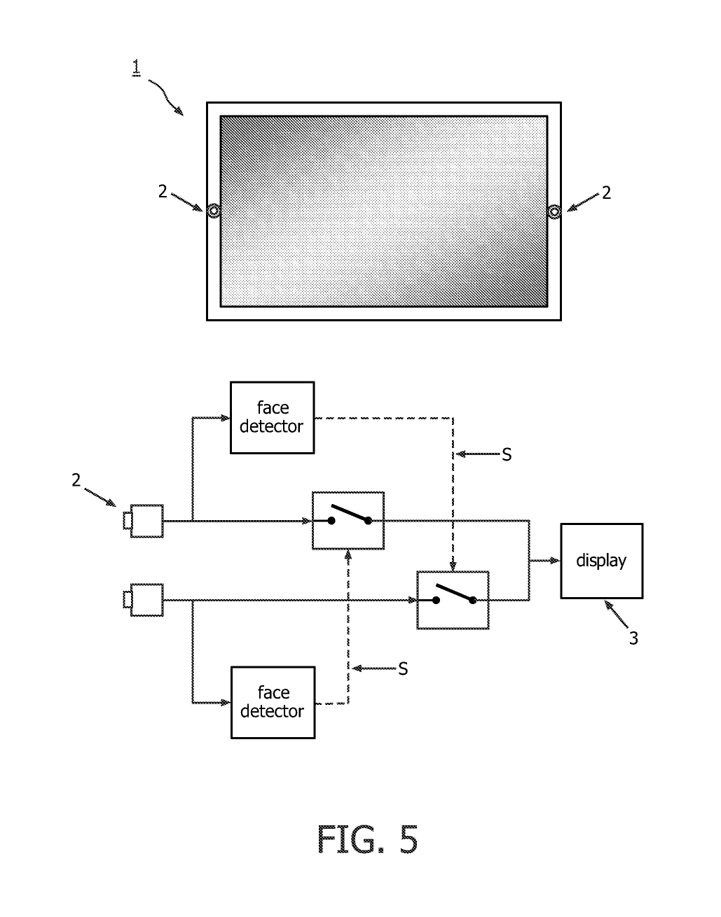

FIG. 5 illustrates yet a further embodiment.

This embodiment is a variation of the embodiment of FIG. 4. However, instead of an orientation sensing camera being used, the images of the left and right camera are sent to an analysis means. In the analysis means the image of the left and right image (or both combined) are analyzed. When it is found that the viewer is looking straight at (with a margin of a number of degrees) the mirror, no signal is sent to the display device and the device acts as a simple mirror due to the semi-transparent reflective layer. When the person is looking in the direction of the right hand camera, the image of the left hand camera is displayed on the display screen and vice versa.

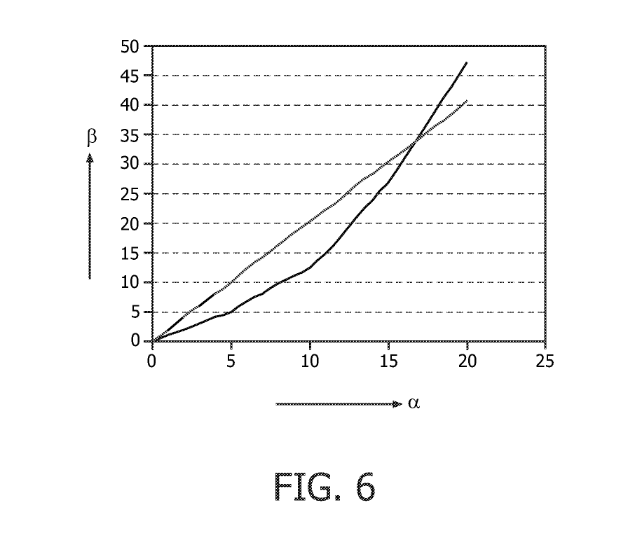

FIG. 6 illustrates embodiments of the invention. In the form of a graph the relation between the angle α at which the head is turned and the angle β at which the displayed head is shown. For a flat mirror these two angles are per definition the same, i.e. α≡β.

The straight line depicts a situation in which the display device does not comprise a reflective semi-transparent layer, and the cameras are always used to record the image and show the head. In this example the relation between the angles α and β is β=2α, i.e. the rotation of a displayed head or torso is exaggerated by a factor of 2. This is a simple linear relation between the two rotation angles. The curved line depicts a situation wherein for small angle, smaller than 5 degrees no image is displayed and the device comprises a semi-transparent reflective layer. Between 0 and 5 degrees of turn both angles are equal to each other since the device works as a simple mirror, wherein the image is reflected in the semi-transparent reflective layer. When one turns the head over an angle larger than 5 degrees, an image is displayed with an exaggerated angle of turn. At first the exaggeration is only small, but it grows as the head is turned more. In this example a non-linear relation between the angles α and β is used.

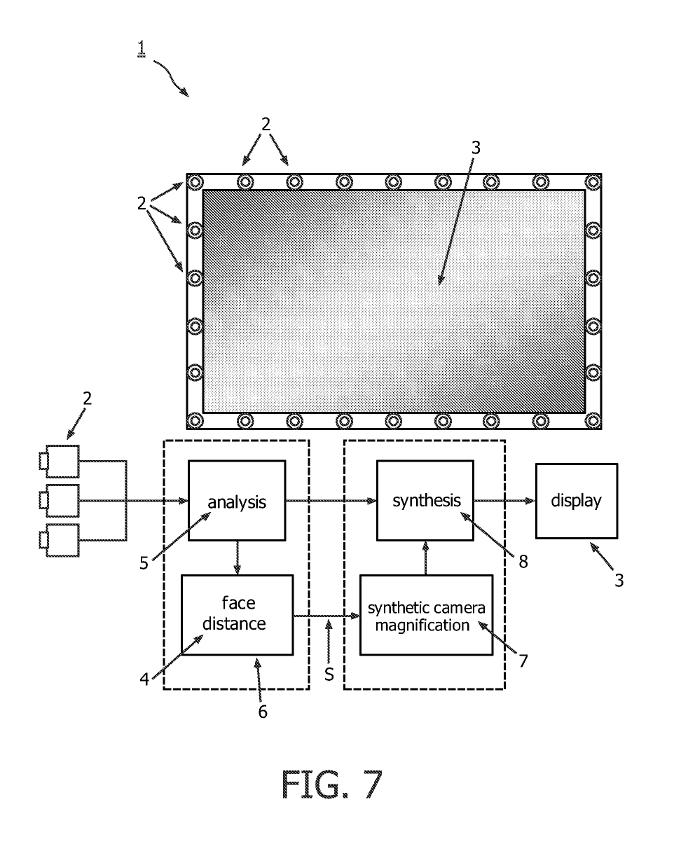

FIG. 7 illustrates a further embodiment of the invention. When one looks into a flat mirror the perceived distance at which the image is formed is the same as the distance between the object and the mirror. It is possible to use a convex mirror which allows magnification of the object. However this is a fixed magnification. Within embodiments of the invention the displayed image is magnified as a function of the distance to the mirror device. Typically, a viewer holds and maintains a certain distance to a mirror. When he/she wants to take a better look at a detail he/she reduces the distance to the mirror. FIG. 7 illustrates an embodiment of the invention.

In FIG. 7 face distance determining means determine the distance of the face in respect of the mirror device. This determination determines the magnification of the displayed image. It is remarked that magnification is in fact equivalent to moving a camera with fixed magnification closer to the object, so all applications can be seen, in fact as changing the point of view, or in other words the position of the camera, be it a real camera or a virtual camera. Exaggerating the angle of rotation means in fact that one shifts the point of view from which the image is recorded further to the left or to the right then one would do for a mirror, amplification equals a shift of the point of view towards the object.

Distance can be determined in various ways, for instance, when using a single camera, the size of object provides a rough estimation of the distance; when two camera's are used, distance can be determined in much the same way as human eyes and brains determine distance namely by the parallax. Ultrasound means can also be used to measure distance, or such means as are regularly used for cameras to focus can be used.

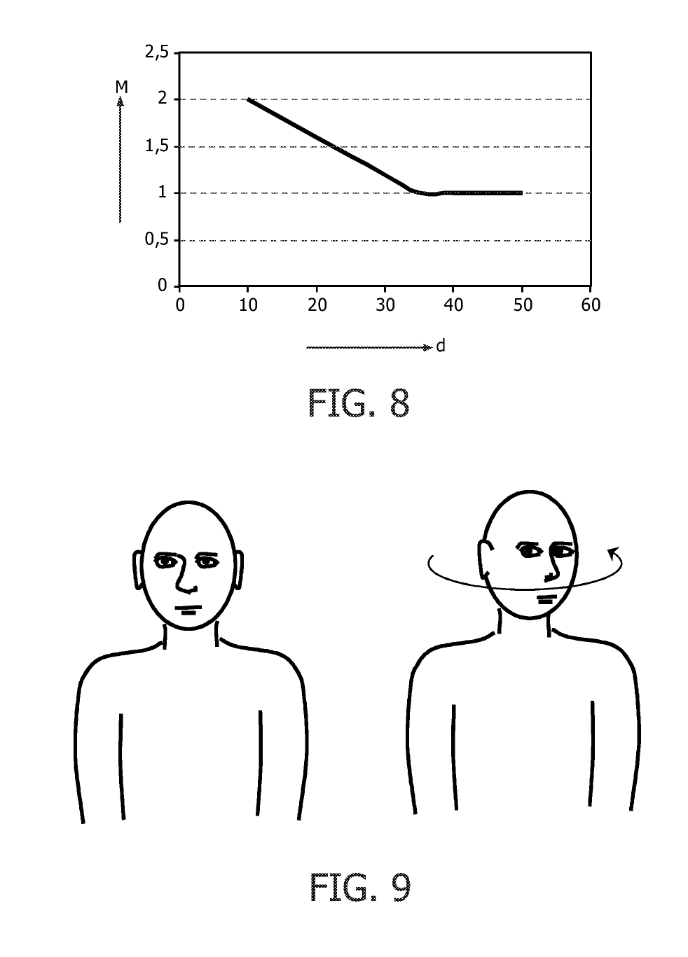

FIG. 8 illustrates an exemplary relation between the magnification M of the image and the distance d in centimeter to the mirror.

For distances d larger than a threshold value, for instance in this example 35 cm distance, the magnification is kept at a fixed value of, in this example 1. This can be done for instance by using the device as a simple mirror, i.e. not displaying an image on the display device, but using the device in the reflective mode. For smaller distances, as the viewer moves his head or torso closer to the display screen, an enlarged image is displayed, i.e. with a magnification larger than 1. To avoid a sudden jump in the image there is a smooth transition between the two regions. In embodiment there can be a range of distances for which the magnification factor is less than 1. This can be for instance useful when a hat is tried on, a normal mirror would show the face, but only part of the hat. By using a magnification smaller than 1, it does become possible to see the hat even at relatively small distances from the mirror. This would also be useful in small size changing cubicles.

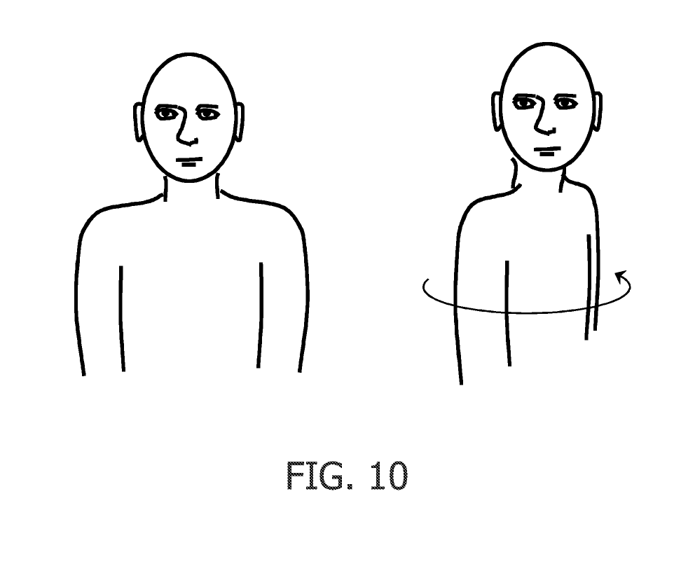

FIG. 9 illustrates turning of the head in front of the mirror; FIG. 10 illustrates turning of the body in front of the mirror.

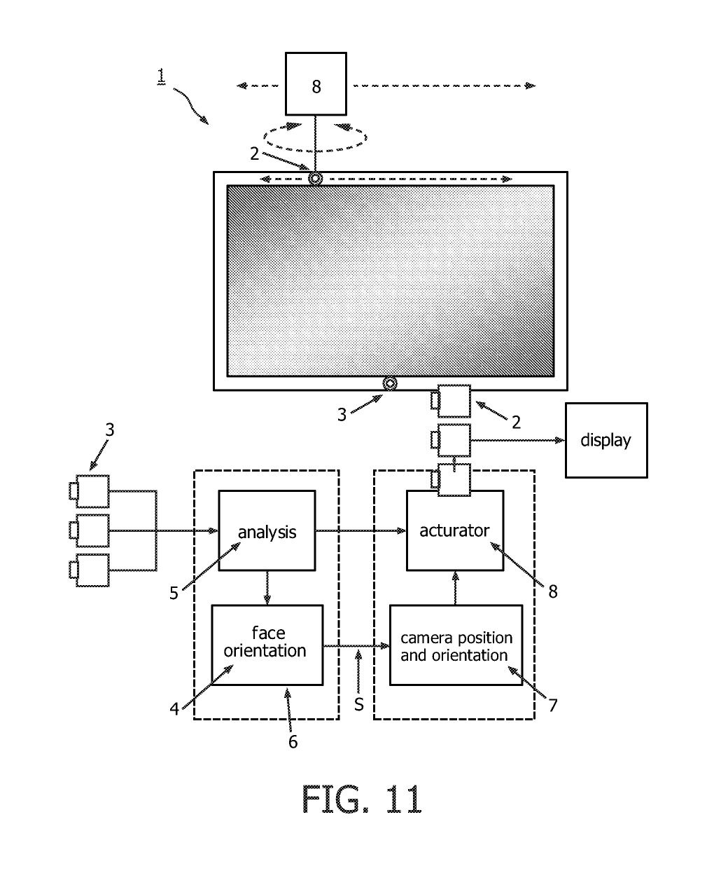

FIG. 11 illustrates an embodiment using a single camera and a rotation sensing means 41. As in the embodiment of FIG. 4, the rotation of the face or body is sensed by rotation sensing means 41. This provides a signal that determines the camera position and possibly also orientation. This drives an actuator 8 which changes the position of the camera.

In embodiments the mirror device is provided with a semi-transparent layer in front of the display device. This layer can be a passive layer or a switchable layer. In preferred embodiments said layer is switchable between a mainly reflective and a mainly transparent mode.

In all embodiments wherein the mirror device switches between a reflective mode and a transparent mode smooth transitions between reflective mode and display mode are preferred embodiments.

A smooth transition can for instance be accomplished by a fade-over, i.e. a gradual change of one mode to another.

One such fade-over would be, in embodiments wherein a switchable reflective layer is used to switch the reflective layer from the first, reflective state, to the second, transparent state gradually, for instance in a range of angles x−Δ to x+Δ where x stands for the angle of orientation or the distance at which the mirror device changes from reflective mode to display mode, and Δ stands for a relatively small range around the transition values.

Likewise, the intensity of the displayed could be turned on gradually over a range of values around a transition value, so that the intensity of the displayed image is gradually increased, rather than turned on at the switch-over.

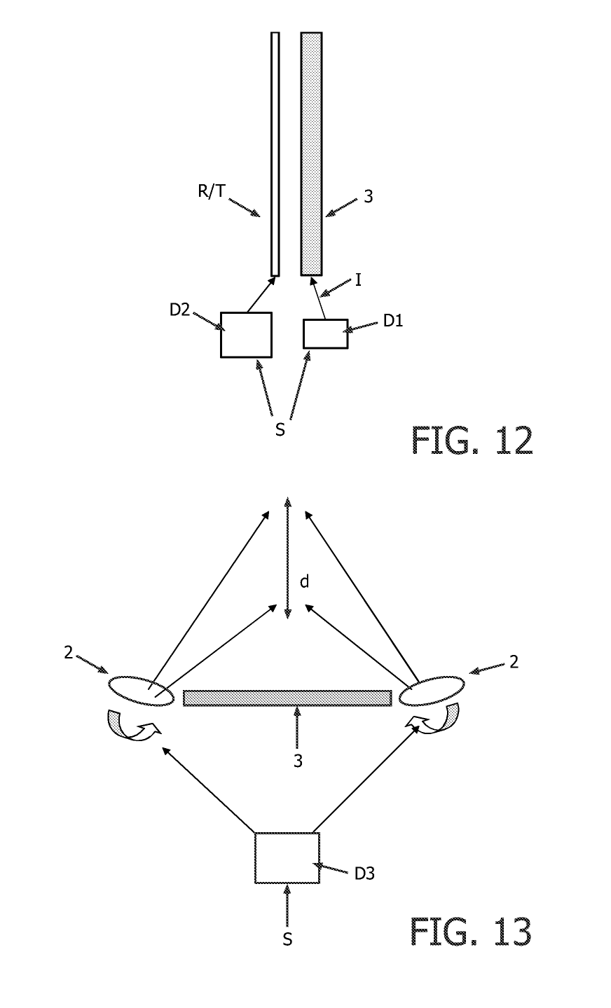

FIG. 12 illustrates an embodiment. In front of the display device 3 a switchable reflective layer R/T is positioned. The signal S determines the mode of this layer, i.e. whether it is reflective or transmitting. The switch-over between the two modes is not a step-function, but an S-function wherein the mid-point of the S-curve is at the threshold value for switching from one mode to another. The drive D2 of this switchable layer is provided with signal S. The intensity I of the display is likewise a function of the signal S, and likewise an S-function wherein the midpoint of the S-curve is at the threshold value for switching on the display device. Drive D1 for driving the display is provided with signal S. Of course, instead of the signal S a signal indicative of or derive from the original signal S can also be used.

Such gradual change could introduce some fuzziness in the image as seen by the viewer, but would prevent sudden jumps in the image.

In the claims, any reference signs placed between parentheses shall not be construed as limiting the claim.

The invention is also embodied in a computer program comprising program code means for performing a method according to the present invention.

The word “comprising” does not exclude the presence of other elements or steps than those listed in a claim. The invention may be implemented by any combination of features of various different preferred embodiments as described above. In particular, but not exclusively, in embodiments rotation as well as magnification of the image can be done simultaneous.

In embodiments the mirror device has means to operate in three modes:

The device has three modes and a means to set the device for instance manually (or for instance by means of remote control) to any of three modes:

a simple display mode to display a movie or television program for instance

a simple reflective mode, to act as a mirror

a dual mode, reflective within a range of angles and/or positions, displaying an exaggerated angle when the head or body is turned.

This would for instance be useful at the beauty parlour. In the first mode the customer can watch a movie, in the second mode, the device is a simple mirror, and the third dual mode can be used when the hairdresser wants to show the customer the result of his efforts. In embodiments a remote control is provided to switch between the modes. A manual control is also possible.

For simplicity and ease of understanding FIGS. 3, 4 and 7 show set-ups in which the orientation (FIGS. 3, 4) respectively the distance (FIG. 7) is measured. Combinations of the two, in which both orientation and distance are measured, form preferred embodiments.

In FIGS. 3, 4 and 7 the cameras are shown in fixed positions. Even if the cameras are in fixed positions, the angle at which the cameras are positioned in respect of the mirror device may still be changed by rotating one or more cameras. Some of the cameras may be fixed in position and angle, while some of the cameras may be movable and/or rotatable.

In those embodiments wherein the distance is measured, the field of view of the cameras is, in embodiments, changed in dependence on the measured distance d. When the subject moves closer to the mirror, not only the magnification is changed, but also the cameras are rotated so that the cameras are pointed at the position of the viewer. This improves the image. To this end the mirror device is provided with means to rotate the means for recording. FIG. 13 illustrates such embodiments. The signal S in indicative of the distance, drive D3 rotates the cameras 2 so that they are pointing at the position of the head of the viewer.

In the above embodiments the display device formed part of the device according to the invention.

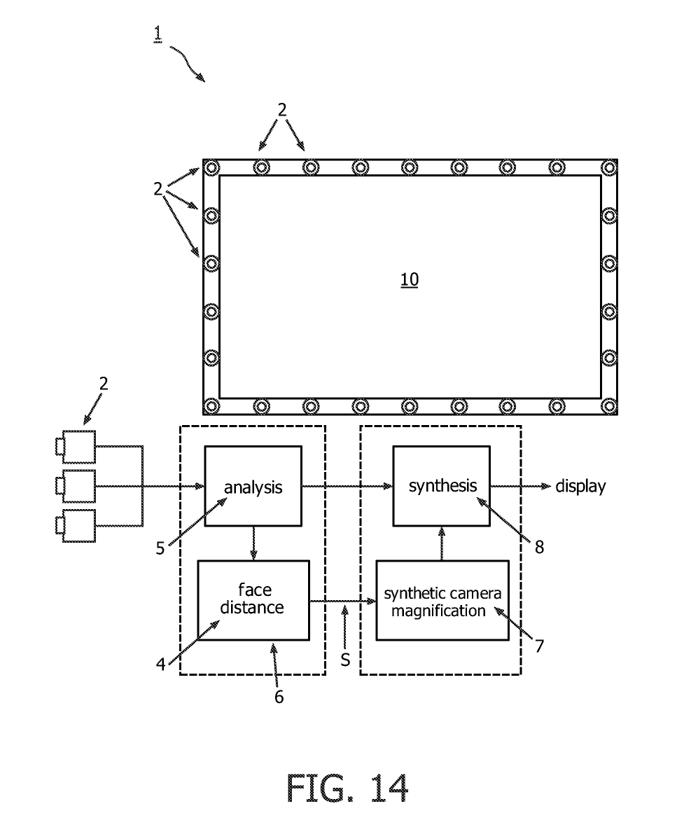

The invention is also embodied in a device or system as shown in FIG. 14. In this aspect of the invention the display itself is not part of the device or system according to the invention, but the device comprises a frame with a recording device to record an image for a display device, a means 4 to determine a position of a body part with respect to the frame, said means outputting a indication signal (S) to indicate the position of the body part of a viewer with respect to the frame, a means to change (7) the view point from which the image is recorded in dependence on said indication signal (S), a means to generate an image signal (I) of the recorded image for display on a display screen of a display device.

FIG. 14 illustrates such embodiments. On position 10 a display can be provided.

This aspect of the invention provides a device or system to convert a regular TV or PC into a mirror device. The advantage is that any display device, or at least many, can be used to provide the advantages of the present invention.

The frame with hard and/or software would form a means for upgrading the TV or PC to provide the TV or PC with a mirror function, with extra possibilities, that it did not have before.

In various different ways such an embodiment of the invention can be made.

For instance, all the necessary soft-and hard-ware can be enclosed within the frame of the device. The device provides a signal to be sent to a display device. Such embodiments can be used to convert a normal TV into a mirror device. The frame is positioned around a screen of a normal TV and the signal is fed to the TV. As an alternative the device could have a frame and a separate box wherein the necessary hard- or soft-ware is provided. Any normal TV can then be converted into a magical mirror.

For use with a PC, or laptop, a somewhat different embodiment is within the scope of the present invention. Around the display screen of the monitor of a PC, or of the laptop, a frame with one or more cameras is positioned. The means for indicating the position and providing a signal S and providing image signal I are preferably in the form of computer programs. The computer programs are loaded on the PC or laptop, a connection is made between the frame and the computer and the image is displayed on the monitor. The frame may comprise a semi-reflective layer. The frame is, in embodiments of a size corresponding to a display device of a laptop.

In the above examples the means for determining orientation are mainly optical means; they could also be acoustical means or other means. Such embodiments form preferred embodiments. An example of another means is, when the device is used in a beauty parlour, the angle of rotation of the chair at which the customer is sitting. By turning the chair slightly, the hairdresser can show the customer the results.

The display device 3 can be a standard 2-D display device. However, preferred embodiments comprise a 3-D auto-stereoscopic device, for instance one using a lenticular screen.

Using a 3-D display, in combination with exaggerated rotation, has a further surprising effect:

When one looks in a mirror, the image one sees is 3 dimensional. However, as one turns the head, even at small angle, the perceived image looses depth, since only one eye is active. This effect is even stronger when a person wears glasses. Without perceiving depth it becomes difficult to work accurately. Using a 3-D display device with exaggerated rotation display, one cannot only see parts of the head that would normally be just out of sight, but even for those areas that are normally within sight, but only visible to one eye, one can now see in three dimension, since one can see with both eyes, and thus with a depth perception. Especially when putting on make-up this can be an important advantage.

In embodiments the image displayed on the display screen is simply the image as captured by the cameras. In further embodiments the displayed image may be an image derived from or associated with the captured image.

A few examples of such embodiments are:

in or for preparation for the application of make-up or grime:

The generated image is the image of the viewer, but as it would look after application of the make-up, i.e. colors, extent of make-up etc. A computer program would overlay and adjust the recorded image to simulate applied make-up. The viewer can than take a good look, and at various angles and maybe even at artificial light conditions or at a magnification to judge the effect of the application of make-up. Only when the viewer is satisfied and has made his/her choice the make up or grime is applied. This safes time and money.

in preparation for cutting hair at the hair-dresser. The shown mirror image is the image of the viewer as taken, but computer altered to provide various different hair styles and color. The viewer can than judge various hairstyles and colors, at various angels. It would allow the customer a much improved mechanism of choosing the hairstyle and color he or she wants, much better than by looking at photos of models with various hairstyles. In such photos the result always looks very good. This will not only safe time and money but also reduce the chance on disappointment.

in preparation for application of tattoos.

in preparation for plastic surgery. In such embodiments the viewer is presented with an image that is composed of his or her own mirror image but altered in a way to represent the expected result after surgery. The patient can view his or her image as would be expected after surgery from various angles in the mirror, and thus get a good look at the expected result and, not unimportantly, get familiar with the expected result. This will allow the patient to discuss different options with the surgeon, and immediately see, with his/her own eyes the expected result of the various options. The patient can even, in the embodiments in which the invention is a frame that can be put in front of a normal TV or computer monitor, take the frame home and show to and discuss the expected results with others.

In dressing rooms: The image provided on the display screen is the mirror image of the viewer, but by computer simulation the image is altered to show the result of a particular dress, gown etc. This would help to make a first selection.

In the above examples the mirror image shown is a composite of the recorded image with some artificial compounds. In most extreme examples the mirror image could be completely or almost completely artificial, though still in pose corresponding in large part to the person sitting or standing in front of the mirror device. For instance in games people often choose a character to represent themselves in the game. The synthesized image would be that of the chosen character. The size of the head would for instance still be in accordance with that of the person sitting in front of the mirror. The viewer can look in the “mirror” and, turning his of her head or body, see a reflected image of the chosen character moving in the same way as the viewer, but with increased angles of view. The viewer can get familiar with the chosen character. Often such characters can be provided with accessories, as in real life. The invention, in this embodiment, allows a viewer to “try on” these accessories in a very natural manner and see the result in the mirror with improved viewing possibilities.

1. Mirror device (1) comprising a display device (3) with a display screen
at least one image recording device (2) to record an image
a means (4, 41) to determine a position of a body part with respect to the display screen of the display device (3), said means outputting a indication signal (S) to indicate the position of the body part of a viewer in front of the display screen
a means to change (7) the view point from which the image is recorded in dependence on said indication signal (S)
a means to display the recorded image on the display screen of the display device (3).

2. Mirror device as claimed in claim 1 wherein the body part is a face or head part or a torso.

3. Mirror device as claimed in claim 1, wherein the means to change the view point are arranged to increase, with respect to a reflected image, the angle of rotation (β) of the displayed image.

4. Mirror device as claimed in claim 1 wherein the means to change the point of view are arranged to change the magnification (M) of the displayed image, with respect to a reflected image.

5. Mirror device as claimed in claim 1, wherein the mirror device comprises a movable camera and means (8) to move the movable camera, wherein the position of the movable camera is determined by the position of the body part with respect to the display screen.

6. Mirror device as claimed in claim 1, wherein the mirror device comprises a number of cameras.

7. Mirror device as claimed in claim 6 wherein an image is synthesized from the images taken by the cameras, the point of view of the synthesized image being dependent on the signal (S).

8. Mirror device as claimed in claim 1, wherein the mirror device comprises a means to determine a position (41) separate from the image recording means.

9. Mirror device as claimed in claim 1, wherein the mirror device comprises a layer in front of the display screen that is switchable between a first reflective state and a second transparent state.

10. Mirror device as claimed in claim 1, wherein the mirror device is provided with a reflective, semi-transparent layer in front of the display screen and the means for displaying the recorded image are arranged such that for a first range of positions, no image is displayed, whereby the reflective layer acts as a mirror, and for a second range of positions, the recorded image is displayed.

11. Mirror device as claimed in claim 10, wherein the reflective semi-transparent layer is switchable between a first state with a relatively high reflectivity and relatively low transparency, and a second state with a relatively low reflectivity and high transparency.

12. Mirror device as claimed in claim 9, wherein the device comprises means (D2) for gradually switching the layer between the first and second state.

13. Mirror device as claimed in claim 1, wherein the mirror device comprises means (D3) for rotation the recording device (2).

14. Device comprises a frame with a recording device to record an image for a display device, a means 4 to determine a position of a body part with respect to the frame, said means outputting a indication signal (S) to indicate the position of the body part of a viewer with respect to the frame, a means to change (7) the view point from which the image is recorded in dependence on said indication signal (S), a means to generate an image signal (I) of the recorded image for display on a display screen of a display device.

15. Device as claimed in claim 14, wherein the frame comprises a semi-reflective layer.
